(19) United States
(12) Patent Application Publication
(10) Pub. No.: US 2016/0082622 A1
(43) Pub. Date: Mar. 24, 2016

(54) DEVICE FOR REMOVING A THREAD FROM A TIRE

(71) Applicant: GOMAVIAL SOLUTIONS S.L, San Sebastián-Guipúzcoa (ES)

(72) Inventors: Leandro ROMERO MARION, San Sebastián-Guipúzcoa (ES); Pablo FERRÓN CELMA, San Sebastián-Guipúzcoa (ES); Alexander MATEOS TORRERO, San Sebastián-Guipúzcoa (ES)

(73) Assignee: Gomavial Solutions S.L., San Sebastián-Guipúzcoa (ES)

(21) Appl. No.: 14/891,128

(22) PCT Filed: May 13, 2014
(86) PCT No.: PCT/EP2014/059706

§ 371 Date: Nov. 13, 2015

(30) Foreign Application Priority Data
May 13, 2013 (EP) 13382176.9

(51) Int. Cl. B29B 17/02; B26D 1/04; B26D 7/02; B26D 3/00

(52) U.S. Cl. CPC B29B 17/02; B26D 3/005; B26D 1/04; B26D 7/02; B29L 2030/002

(57) ABSTRACT

The present invention relates to a device for removing a tread from a tire or part of a tire allowing the subsequent use thereof as an independent product in other industries. Another object of the invention is the method which allows establishing suitable pre-cuts and the subsequent removal thereof. The configuration of the machine allows automated tread removal in a very short time. The particular configuration of the cutting means allows removing helical cut portions for obtaining longer bands.

### OBJECT OF THE INVENTION

The present invention relates to a device for removing a tread from a tire or part of a tire allowing the subsequent use thereof as an independent product in other industries. Another object of the invention is the method which allows establishing suitable pre-cuts and the subsequent removal thereof.

The configuration of the machine allows automated tread removal in a very short time.

The particular configuration of the cutting means allows removing helical cut portions for obtaining longer bands.

### BACKGROUND OF THE INVENTION

Recycling tires disposed of each year is of great importance today since, they take up one of the largest wastes in civilized societies. Thus, more than 230,000 tons of worn tires are generated each year in Spain.

At least three main layers must be provided in the tire manufacturing process: the tread band, sometimes also called KM band, formed by textile fibers embedded in rubber or only rubber in truck tires; the metal mesh, formed by a generally oblique framework of wires; and the casing on which the other two layers are arranged. As indicated by the name, the fibers of the casing in radial tires are radial fibers. Depending on the type of vehicle, the tire can contain more than one metal mesh and more than one tread layer. After manufacturing the tire these layers are not distinguished through an inner separation surface but rather are embedded in the rubber and spaced from one another providing different resistance functions to the overall tire performance.

When the outer tread band has lost the groove depth needed for proper traction with the asphalt, the tire is disposed of.

In the state of the art, there are different alternatives for proceeding with these used tires, such as for example:
Technologies outside material recycling systems, which include recapping, making use of the casing of the tire.
Mechanical treatments where the tire is ground.
Size reduction technologies by means of milling which allows obtaining rubber powder. The processes applied can be mechanical processes at room temperature, or cryogenic or wet milling.
Regeneration technologies: recovering or reclaiming and devulcanizing.
Other technologies such as pyrolysis and thermolysis.

The most common solutions, for example, are therefore based on completely grinding used tires, subsequently removing their components using complex machines. Said machines follow a grinding process which requires a lot of energy, in addition to using large and expensive magnets for removing the metal mesh scrap.

The main technical problem solved by the present invention is to provide a simple and economical alternative in tire recycling. In the state of the art, a tire is considered a set of materials mixed in a complex manner from which the components thereof are to be reclaimed, searching for ways to separate each component.

The present invention allows obtaining new products from the tire or from a part thereof. It can be interpreted that tire manufacture is an initial manufacturing phase of these new products therefore the steps of the invention themselves complete these initial manufacturing steps until obtaining the desired product.

### DESCRIPTION OF THE INVENTION

A first aspect of the invention is a machine suitable for removing a tread from a tire or a part thereof. The expressions “or part of a tire” or “or a part thereof” are used because it is possible to have a tire from which a component has been removed such that it still has a circular structure and the tread. The machine according to the invention also allows removing the tread from such element. Throughout this description, the term tire can also be understood as a part thereof.

The machine according to this first inventive aspect comprises:
first fixing means suitable for securing the tire and for allowing a turn by rotation of said tire with respect to its main axis,
first driving means suitable for imparting a turn by rotation of the tire with respect to its main axis,
first cutting means suitable for making two perimetral cuts one on either side of the tread of the tire,
second cutting means suitable for making a cut in the tread transverse to the tire giving rise to a flap,
pulling means for pulling the flap, the flap can be obtained by means of the second cutting means, for removing the tread by pulling and ripping.

The first fixing means are responsible for fixing the tire to the machine. These means allow the tire to rotate around its main axis to enable acting on its entire perimeter, for example, for making pre-cuts. These pre-cuts are cuts that are made on the surface of the tire, with a specific depth, so that during the removal of the tread by pulling, the ripping, is guided and limited by these pre-cuts.

The first cutting means are responsible for the perimetral cuts leaving the tread to be removed between them. With these pre-cuts, the tread is still a continuous circular element. A subsequent transverse cut generates a flap giving rise to the start of the band to be removed. This subsequent transverse cut is made through the second cutting means. In a preferred embodiment of the invention, these cutting means act by obliquely penetrating the tread not only to establish the beginning of the band, to be removed as it is a transverse cut, but rather to lift a flap when this start of the band begins to be separated from the tire. This cut is made between the layer of nylon cords arranged parallel to the perimeter of the wheel, which are also called a crown belt, and the layers of metal cords forming an angle with the nylon cords. It has been proven that the effective way of removing the tread is when the preceding condition is verified where the nylon cords are on the side of the tread to be removed. The complete removal of the tread is obtained by pulling this flap.

where the pulling means for pulling the flap comprise:
a rotary drum for winding the removed tread,
second driving means for acting on the rotary drum for removing the tread by pulling,
   and where the rotary drum has anchoring means therein for fixing the flap.

The main cause of tread removal efficiency and automation is the means whereby the tread is pulled once the perimetral pre-cuts and the flap are generated.

The device according to the invention comprises a rotary drum for winding the tread which can be operated by means of the second driving means.

There are anchoring means inside the drum. The flap generated in the tread reaches the anchoring means which secure it. Once the flap of the tread is secured, the actuation of the second driving means cause the rotation of the drum. This rotation of the drum pulls the tread which is being gradually torn oft the tire or a part thereof. Tearing is a process whereby free surfaces are generated in the slit which progresses as the tread is separated from the rest of the tire. The surface which is generated is laterally limited by the perimetral pre-cuts.

This band generated by tearing is wound on the drum. The drum rotates until the tread has been completely removed.

Once the band has been completely removed, the rotation of the drum in the reverse direction unwinds the band. A platform made up of a plurality of wheels on which the removed tread extends as it unwinds has been included in a preferred example. Once unwound, the anchoring means are released and are ready to carry out the next removal.

Various ways for configuring the machine will be described in greater detail below with the aid of the drawings.

### DESCRIPTION OF THE DRAWINGS

The foregoing and other features and advantages of the invention will be better understood from the following detailed description of a preferred embodiment provided only by way of non-limiting illustrative example, in reference to the attached drawings.

FIG. 1 shows an embodiment of the invention. The perspective view is observed from a slightly lowered position to allow observing the details of the cutting and pulling elements. In this figure, partitions and protections have been eliminated to observe the inner parts of the machine.

FIG. 2 shows the same example as FIG. 1. The figure is also a perspective view with the exception that the point of view is located from another side and in a slightly elevated position.

FIG. 3 shows the same embodiment as the preceding figures, in a perspective view and the point of view is located at the front. In this figure, the tire and the perimetral cutting elements have been removed to allow observing the first driving means and the fixing means for the tire.

FIG. 4 shows a perspective view of an isolated drum which allows pulling and winding the tread.

FIG. 5 shows a perspective view of the area of the machine where the first cutting means making the perimetral cuts in the tire are located.

FIG. 6 shows a perspective view of the isolated driving means of the tire for rotating same and for making perimetral cuts.

FIG. 7 shows a perspective view of the isolated first cutting means which generate the perimetral cuts.

FIG. 8 shows a perspective view of the isolated second cutting means which generate the flap.

FIG. 9 shows an embodiment of a cut made on the tire, only a single blade being necessary.

### DETAILED DESCRIPTION OF THE INVENTION

According to the first inventive aspect, the present invention relates to a devise for restoring the tread from a tire (6).

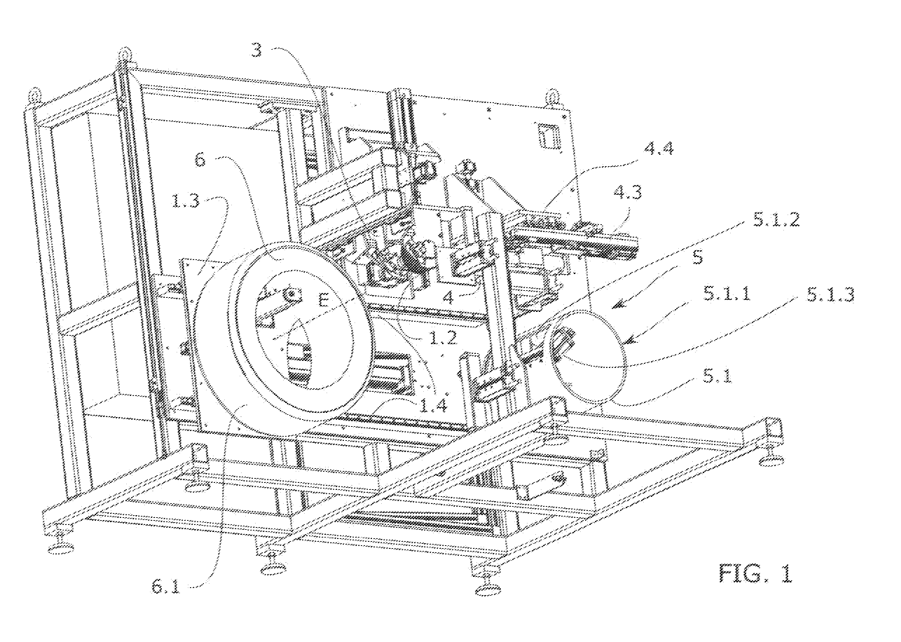

FIG. 1 shows an embodiment of the invention according to a first inventive aspect. This figure shows a perspective view of the support structure formed by square-section bars serving as a fixing for each of the components of the machine seen from a point of view located below the plane serving as a support base for the machine. Likewise, for the sake of clarity, protections for the user such as partitions and doors have been eliminated such that the described components can be seen.

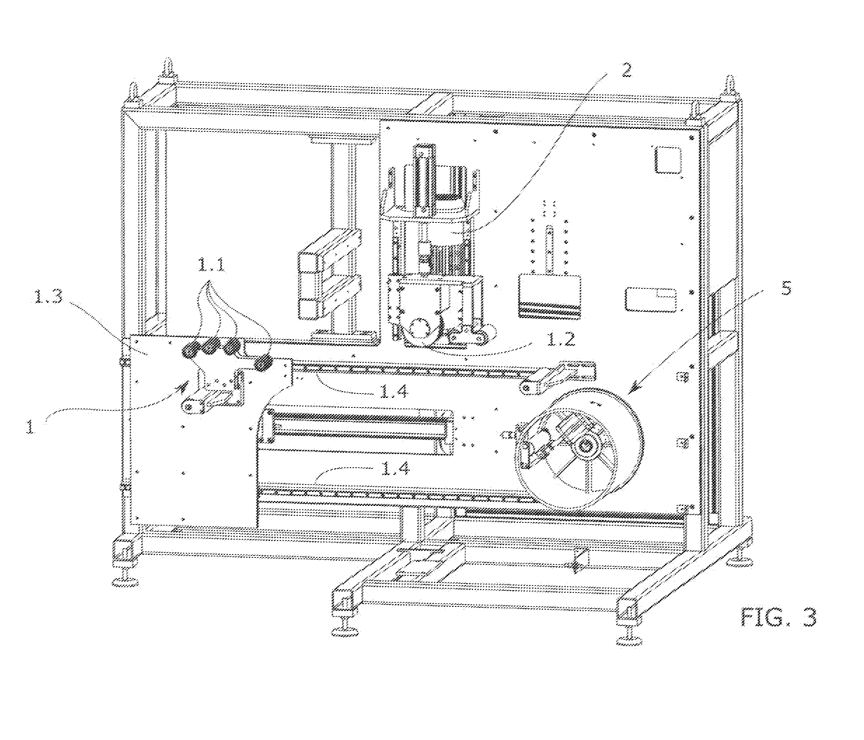

Fixing means (1) on which the tire (6) is supported are located to the left of the machine. These fixing means (1) are more clearly observed in FIG. 3 given that the tire (6) has been removed. In this embodiment, the fixing means are formed by a plurality of wheels (1.1) intended for the tire to internally rest thereon and are arranged forming a circular arch section.

The plurality of wheels (1.1) on which the tire (6) rests are free such that the tire (6) can rotate around its main axis (E). FIG. 3 shows the plurality of wheels (1.1) located on a plate (1.3) that is linearly movable along several guides (1.4). In this embodiment, the guides are arranged horizontally which allows conveniently placing the tire (6) outside the means acting on the tread (6.1) and the tire (6) can then move closer to the means for removing the tread (6.1) which will be described in greater detail below.

Once the tread (6.1) is removed, the rest of the tire that remains can also move again, moving away from the actuation means for removing the tread of (6.1), in this case, moving to the left as shown in the figure, and said rest of the tire (6) can be conveniently retrieved.

Also following the chosen view in FIGS. 1 to 3, moving closer to the means for removing the tread (6) is a movement to the right. In this embodiment, the plate (1.3) on which the free wheels (1.1) are fixed slides along its guides (1.4) for moving closer to or away from the means.

Once the tire (6) has moved closer, the tread (6.1) or the outer face of the tire (6) contacts a cogwheel (1.2) leaving the tire (6) trapped between the plurality of free inner wheels (1.1) and said cogwheel (1.2).

The cogwheel (1.2) is operated by a drive motor (2) imparting a rotation to the tire (6) such that the tire (6) rotates with respect to its axis (E).

Although not seen in the drawings due to the small size thereof, ultrasound-based proximity sensors have been arranged in a lower position with respect to the tire (6). Given that the tire is secured in the upper part, the use of tires having a different diameter causes lower points of the tire (6) to be located at a different height. Tires (6) having a greater diameter will have their lower point located in a lower position.

This sensor establishes the lower point reached by the tire (6). By knowing the position of the inner wheels (1.1) it is possible to calculate the diameter of the tire (6) by processing means. Once the diameter of the tire (6) is known, control means acting on the driving means (2) of the cogwheel (1.2) allow establishing the number of times the tire (6) must rotate to achieve a complete turn or the angle at which said tire (6) is to be rotated.

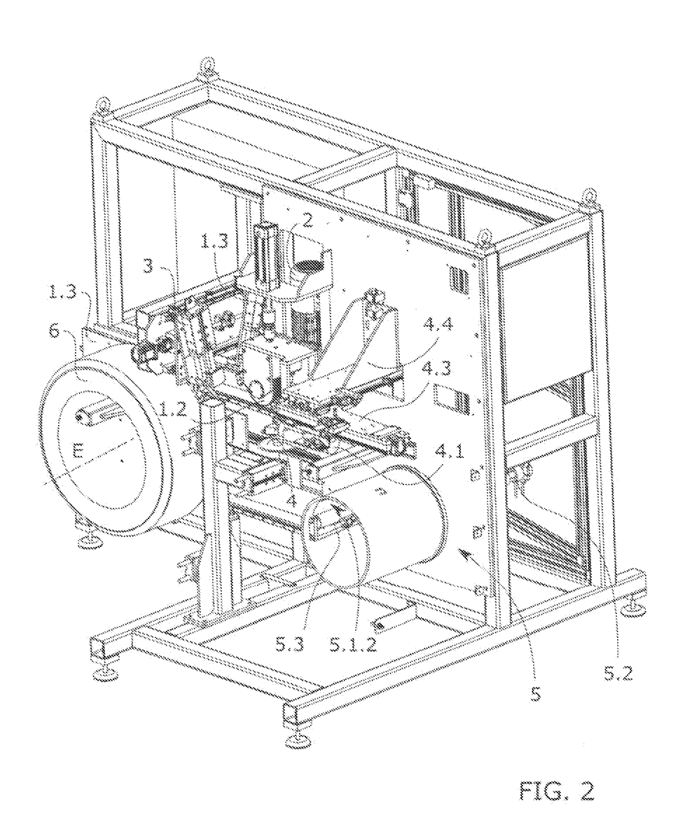

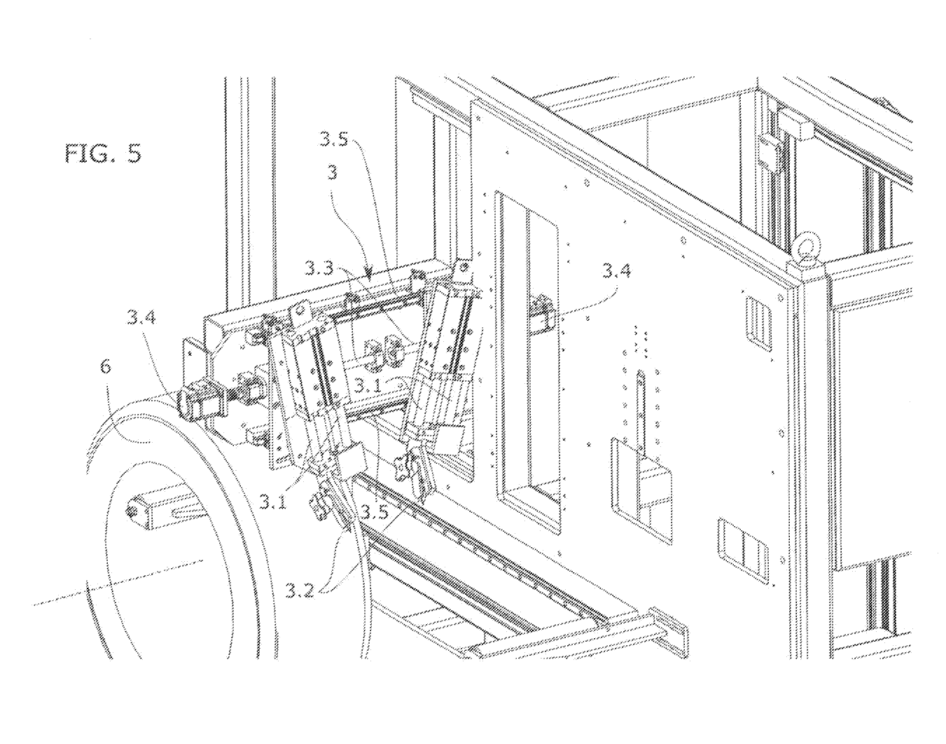

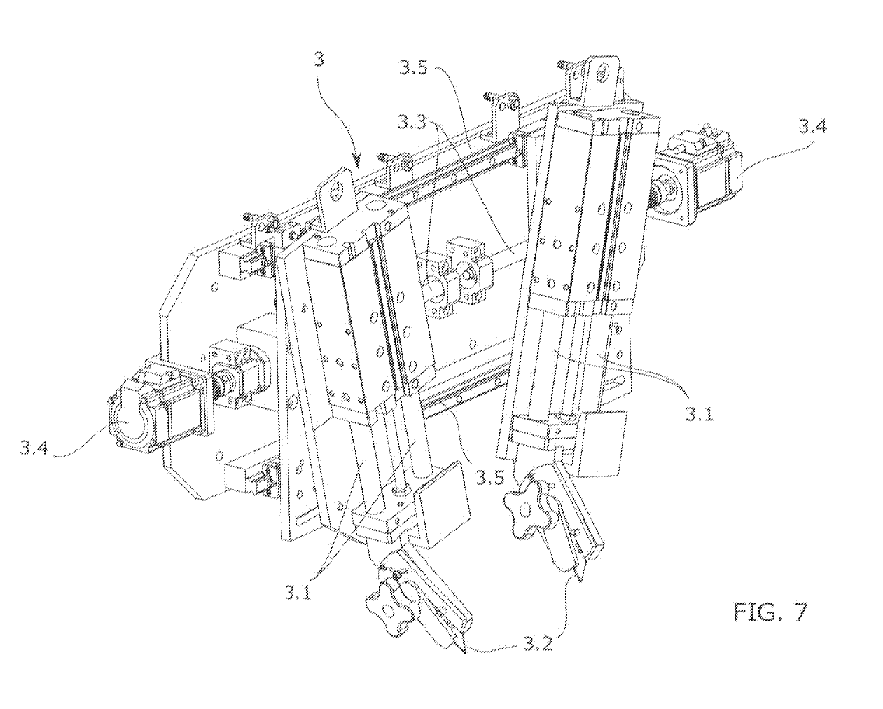

FIGS. 1 and 2 show the first cutting means (3) responsible for making the perimetral cuts. FIG. 3 only shows two support arms for supporting these first cutting means (3) so as to not block other described elements. The first cutting means (3) are observed in detail on the support arms in FIG. 5 and in an isolated manner in FIG. 7. The points of view of these perspectives coincide with the point of view chosen for FIG. 2.

The first cutting means (3) are made up of at least one blade (3.2). In this embodiment, two blades (3.2) are incorporated because the two cuts between which the band to be removed is arranged are obtained in the same rotation of the tire (6). The cut by the first cutting means (3) is obtained by the rotation of the tire (6) by the first driving means (2) and the support of the blade (3.2) against the surface of the tire (6).

As shown in FIG. 7, each of the blades (3.2) is fixed to the end of actuation means (3.1) formed by linear actuators in this embodiment. The extension of the linear actuators (3.1) lowers the blades (3.1) so that they rest on the tire (6). FIG. 5 shows the position of the tire (6) before being located under the blades (3.2). If the tire (6) moves linearly to the right by means of the guides (1.4) of its fixing means (1), it is then located under the blades (3.2). The extension of the linear actuators (3.1) not only places the blades (3.2) on the tire (6) but rather exerts pressure to favor cutting with the rotation of the tire (6).

The tire (6) has no chamber or inner support throughout its entire surface which prevents deformation when pressure is exerted on the outer surface of the tire (6). This means that the force of the blades (3.2) gives rise to a deformation of the tire (6) while the cut is being made. If the two blades (3.2) demarcating the band to be removed are located parallel to one another, the deformation gives rise to a side surface of said removed band which is inclined and not parallel. For this reason, both the blades (3.2) are shown as being oblique, compensating for the inclination caused by the deformation of one tire (6) while cutting.

In this embodiment, the fixing of the linear actuators (3.1) to their support allows modifying the inclination. These supports are in turn located on linear guides (1.5) arranged transverse to the tire (6); i.e., located parallel to the main axis (E) of the tire (6). The transverse movement of the blades (3.2) allows moving the blades (3.2) transversely. This transverse movement is driven by a motor (3.4) acting on spindles (3.3). It is possible to determine the transverse position of each of the blades (3.2) according to the number of turns of the motor (3.4). Each blade (3.2) has its motor (3.4) and a spindle (3.3) so the movement of each of the blades (3.2) is independent.

The transverse movement of the blades (3.2) allows adjusting the position of each blade (3.2) to the limit of the tread (6.1). The tread limit of tires (6) of different width will be in different transverse positions. Control means acting on the motors (3.4) which act on both spindles (3.3) allow adjusting the position of both blades (3.2).

A second proximity sensor located facing the outer side of the tire (6), the side opposite the side resting on the movable plate (1.3), allows determining the width of the installed tire. The control means which act on the drive motors (3.4) of the spindles (3.3) receive the value measured in the second proximity sensor and determine the position of the blades (3.2).

In this embodiment, each blade (3.2) has its own actuation means for transverse movement. It is possible that only one of the blades (3.2) is capable of moving along the entire width of the tread (6.1).

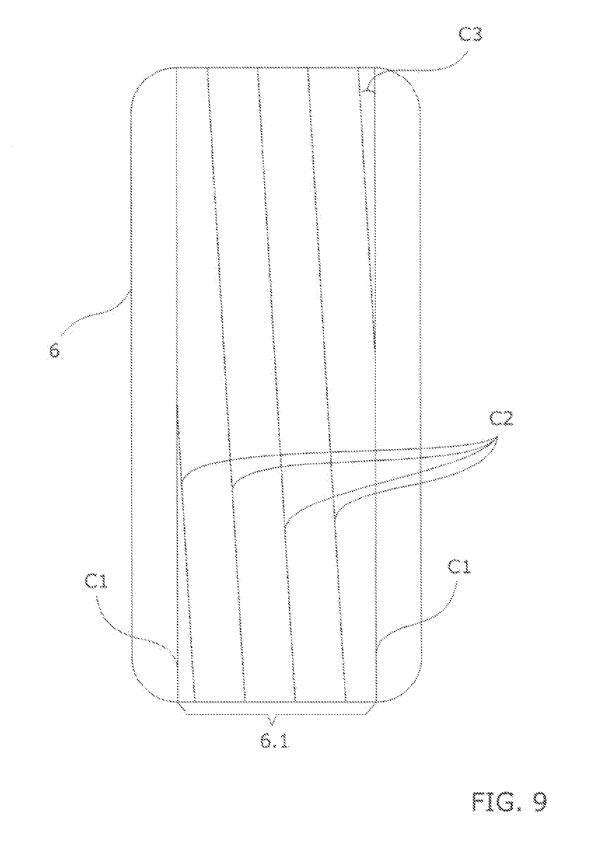

FIG. 9 shows an embodiment of a cut made on the tire (6), only a single blade (3.2) being necessary. A removed band which is longer than the perimetral length of the tread (6.1) is further obtained in this example.

The cut shown in this embodiment is made by means of the following steps:
the diameter of the tire is automatically determined preferably by means of the first proximity sensor,
the total width of the tire (6) is preferably determined by means of a second sensor,
a pitch or width of the band to be removed is established,
the number of turns giving rise to the pitch or width of the band to be removed is calculated with the determined diameter of the tire (6),
the blade (3.2) is positioned on one side of the tread (6.1) and the tire (6) is rotated to make a first perimetral cut,
once the perimetral cut is obtained, the blade (3.2) is moved laterally in synch with the rotation of the tire (6) giving rise to a helical cut with the previously determined pitch or width of the band to be removed,
once the opposite side of the band is reached, a complete groove is made without the side movement giving rise to the perimetral cut.

The perimetral cuts obtained with the same blade can be made independently even with the two blades (3.2), nevertheless, the method described above allows obtaining all the necessary perimetral cuts in less time and without stopping the rotation of the tire.

This same FIG. 9 shows the cut of the flap (6.1.1). This cut of the flap (6.1.1) does not extend along the entire width of the tread (6.1) but only along the width of the band to be removed, generating a start for tearing.

In FIG. 9, the perimetral side cut is depicted by means of continuous line C1, the helical cut is depicted by means of dotted line C2 and the transverse cut giving rise to the flap (6.1.1) is depicted by means of C3.

The band to be removed is torn off in the same manner as the tread (6.1) when only two perimetral side cuts have been made even though it is necessary for the rotary drum (5.1) to make more turns until the entire length is successfully torn off.

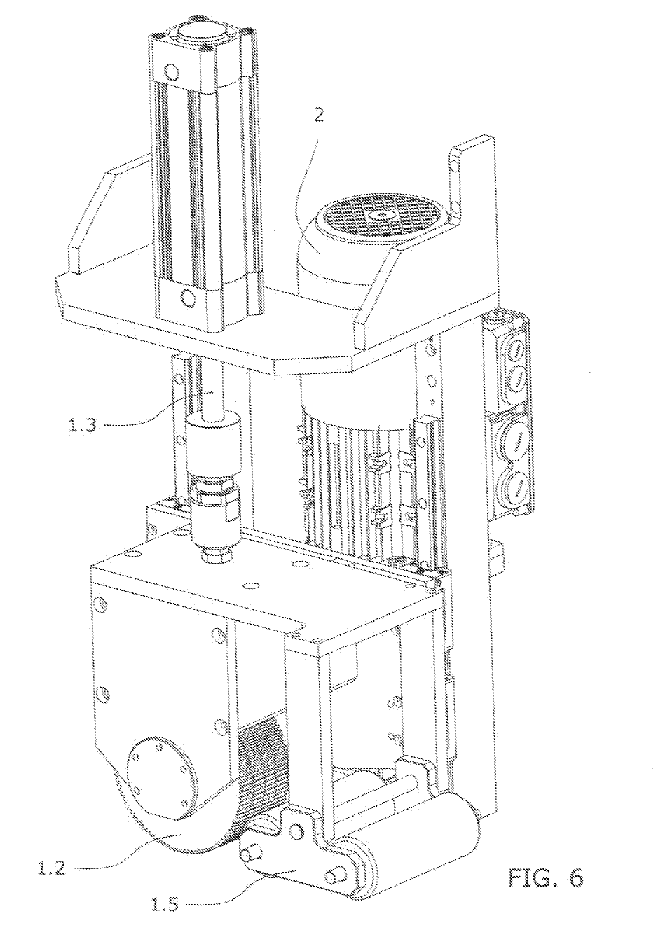

FIG. 6 shows the driving means of the tire (6) in an isolated manner. The cogwheel (1.2) is vertically movable by a linear actuator (1.3) such that as it moves closer to the tire (6), the cogwheel (1.2) moves down until it contacts the tire (6). This is how the tire (6) is trapped between the inner wheel or wheels (1.1) and the cogwheel (1.2), giving rise to the fixing means (1) for the tire (6). The drive motor (2) rotates the cogwheel (2) which in turn drives the tire (6). Given that the wheel (1.2) is a cogwheel the grip on the tire (6) which is gradually torn by the movement of the cogwheel (1.2) is favored.

The figure also shows support rollers (1.5) guiding the exit of the tread (6.1) as it is being removed.

Once the flap (6.1.1) and the perimetral pre-cuts (C1) are generated, the band to be removed is pulled on either for removing the entire tread (6.1) or for removing a longer band by means of the additional helical cut (C2).

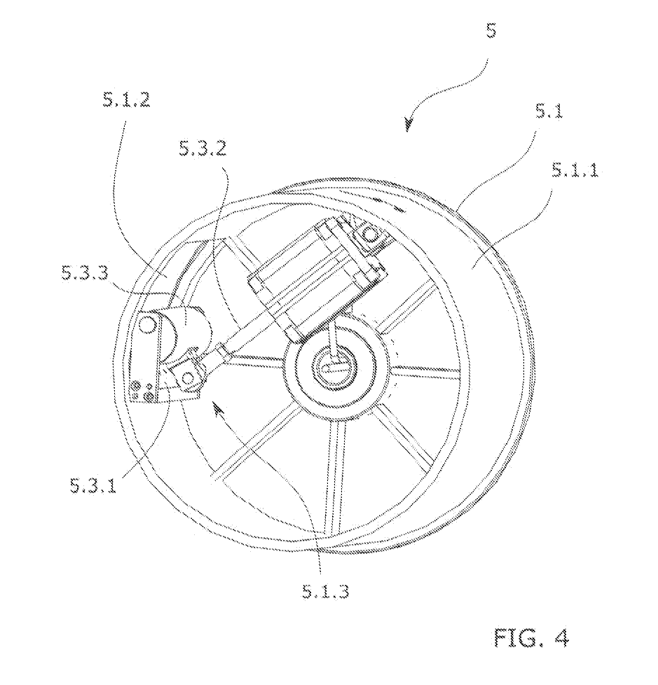

This removal is carried out by means of pulling means (6) formed by a drum (5.1). The pulling means are particularly shown in an isolated manner in FIG. 4 and in an operating position in FIGS. 1, 2 and 3.

The flap (6.1.1) projects from the surface of the tire (6) such that it meets up with the drum (5.1) as the tire rotates clockwise in this embodiment. In this embodiment, the drum (5.1) is formed by a cylindrical surface (5.1.1) housing anchoring means (5.1.3) therein for anchoring the flap (6.1.1). These anchoring means (5.1.3) arranged inside the drum (5.1) are accessible for the flap (6.1.1) by means of a window (5.1.2). If the drum were formed by a plurality of circularly distributed parallel bars spaced from one another, for example, the window (5.1.2) would not be necessary.

As the tire (6) rotates, the flap (6.1.1) abuts with a transverse support (5.3.1) integral with the drum (5.1) which favors the introduction of the flap (6.1.1) into the drum (6.1). a linear actuator (5.3.2) acts on a cylinder with the axis of rotation located close to the periphery such that it is configured as a cam. The movement of the linear actuator (5.3.2) rotates the cam-like cylinder such that it acts as a second support (5.3.3) integral with the moving element of the linear actuator (5.3.2) where the extension of the linear actuator (5.3.2) moves the second support (5.3.3) closer to the first transverse support (5.3.1) trapping and anchoring the flap (6.1.1) of the tread (6.1) for pulling it.

According to another embodiment, the rotation of the moving support can also be achieved with a rotary actuator. According to another embodiment, the anchoring of the flap (6.1.1) can be achieved by using an operable clamp.

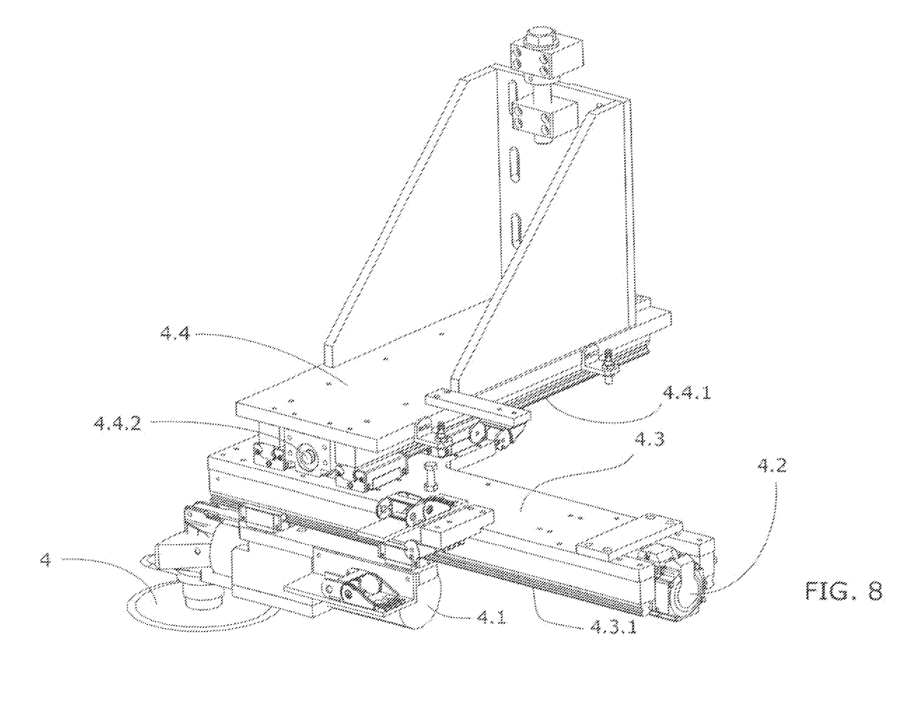

An important element is the device which allows making the transverse cut for obtaining the flap (6.1.1). This device, generically indicated as the second cutting means (4), is shown in its operating position in FIGS. 1 and 2, and in an isolated manner in FIG. 8. The view of FIG. 8 corresponds to the point of view used in FIG. 2.

According to this embodiment, the second cutting means (4) are made up of a horizontally arranged blade (4) with vibrating capacity. The blade (4) obliquely attacks the tire (6) since it moves in a plane located below the plane tangent to the upper point of the tire (6) and above the mid-lane passing through the main axis (E) of the tire (6). The expression “upper point” is understood as the highest point with respect to the base of the machine.

The movement in the horizontal plane located between the plane tangent to the upper point and to the mid-lane is achieved by means of two degrees of freedom. FIG. 8 shows the blade (4) integral with the vibratory actuator (4.1) where both of them are movable along a linear guide (4.3.1) integral with an intermediate support (4.3). The linear movement along this linear guide (4.3.1) is achieved by means of a motor (4.2) determining the position along the linear guide (4.2.1).

The intermediate support (4.3) is in turn movable according to a transverse direction along a second linear guide (4.3.1) integral with a fixed support (4.4) attached to the frame of the machine. This movement is also driven by a motor which acts on a spindle (4.4.2) the end of which is shown in this FIG. 8.

The combination of these two movements which are perpendicular to one another allows movement along the horizontal plane. In this embodiment, the linear movement of the blade (4) along the linear guide (4.3.1) integral with the intermediate support (4.3) causes being moved closer to or away from the tread (6.1) of the tire (6). The second movement is transverse to the tire (6). Control means gradually establish transverse movements followed by one or more longitudinal approaching and distancing movements until reaching the inner metal structure of the tire. A flap (6.1.1) is obtained at the end of this combination of movement. If a helical band is chosen, then the cut must be made at the start of the helical band.

1. A machine suitable for removing a tread (6.1) from a tire (6), characterized in that it comprises:
first fixing means (1) suitable for securing the tire (6) and for allowing a turn by rotation of said tire (6) with respect to its main axis (E),
first driving means (2) suitable for imparting a turn by rotation of the tire (6) with respect to its main axis (E),
first cutting means (3) suitable for making two perimetral cuts one on either side of the tread (6.1) of the tire (6),
second cutting means (4) suitable for making a cut in the tread (6.1) transverse to the tire (6) giving rise to a flap (6.1.1),
pulling means (5) for pulling the flap (6.1.1), the flap (6.1.1) can be obtained by means of the second cutting means (4), for removing the tread (6.1) by pulling and ripping,
where the pulling means (5) for pulling the flap (6.1.1) comprise:
a rotary drum (5.1) for winding the removed tread (6),
second driving means (5.2) for acting on the rotary drum (5.1) for removing the tread (6.1) by pulling, and where the rotary drum (5.1) has anchoring means (5.3) therein for fixing the flap (6.1.1).

2. The machine according to claim 1, characterized in that the rotary drum (5.1) is configured by means of a cylindrical surface (5.1.1), preferably having a circular section, comprising a window (5.1.2) on said surface for the passage of one end of the tread (6.1) with its flap (6.1.1) for fixing the flap (6.1.1) in the anchoring means (5.3) intended for fixing the flap.

3. The machine according to claim 1, characterized in that the anchoring means (5.3) for fixing the flap are made up of:
a first transverse support (5.3.1) integral with the drum,
at least one linear actuator (5.3.2); and,
a second support (5.3.3) integral with the moving element of the linear actuator (5.3.2),
such that the extension of the linear actuator (3.3.3) moves the second support (5.3.3) closer to the first transverse support (5.3.1) trapping and anchoring the flap of the tread for pulling it.

4. The machine according to claim 1, characterized in that the anchoring means (5.3) for fixing the flap are made up of:
a first transverse support (5.3.1) integral with the drum,
at least one rotary actuator (5.3.5); and,
a second support made up of a cam integral with the moving element of the actuator,
such that the rotation of the rotary actuator (5.3.5) by means of the rotation of the cam reduces the distance between the second support and the first transverse support (5.3.1) trapping and anchoring the flap of the tread for pulling it.

5. The machine according to claim 1, characterized in that the fixing means (1) suitable for securing the tire and for allowing a turn by rotation of said tire with respect to its main axis are made up of one or more support wheels (1.1) intended for the inner face of the tire to rest thereon; and a wheel (1.2) intended for resting on the outer face of the tire leaving the tire trapped between the inner wheel or wheels (1.1) and the outer wheel (1.2).

6. The machine according to claim 5, characterized in that the driving means suitable for imparting a turn by rotation of the tire with respect to its main axis are made up of a drive motor (2) for driving the wheel (1.2) intended for resting on the outer face of the tire (6) which in turn rests on one inner support wheels (1.1).

7. The machine according to claim 1, characterized in that the second cutting means (3) suitable for making a cut in the tread transverse to the tire giving rise to a flap (6.1.1) sore made up of a blade located in a support movable according to two degrees of freedom, a first degree of freedom movable according to the direction transverse to the tread, and a second degree of freedom movable in a direction essentially perpendicular to the first degree of freedom for moving the cutting means closer to or away from the tread (6.1).

8. The machine according to claim 1, characterized in that the first cutting means (3) suitable for making two perimetral cuts one on either side of the tread (6.1) of the tire (6) are made up of blades (3.2) integral with actuation means (3.1) suitable for providing at least two positions: a first withdrawn position and a second operating position penetrating the tire (6) for cutting it through the rotation of the tire (6).

9. The machine according to claim 1, characterized in that the first cutting means (3) suitable for making two perimetral cuts one on either side or the tread (6.1) of the tire (6) are made up of blades (3.2) which allow an inclination adjustment with respect to the tread so that the deformation of the tire (6) while cutting results in a side cut surface of the tread that is perpendicular to the main surface of the tread.

10. The machine according to claim 1, characterized in that it comprises at least one sensor for determining the diameter of the wheel, the width of the wheel or both dimensions.

11. The machine according to claim 10, characterized in that the sensor for determining the diameter of the wheel, the width of the wheel or both dimensions is an ultrasonic sensor for measuring proximity, located such that it is spaced from the wheel.

12. The machine according to claim 1, characterized in that it has longitudinal cutting means arranged in synch with the first fixing means (1) which are suitable for allowing the turn by rotation of the tire (6) with respect to its main axis (E) such that the longitudinal cutting means move transversely in correspondence with the rotation of the tire (6) to give rise to a helical cut in the tread.

13. The machine according to claim 12, characterized in that the synchronous relationship between the longitudinal cutting means and the first fixing means (1) which are suitable for allowing the turn by rotation of the tire is a linear relationship for obtaining a band of constant width.

14. The machine according to claim 1, characterized in that it has control means suitable for establishing the number of turns of the tire based on the signal obtained in the sensor for determining the diameter of the tire.

15. A method for obtaining pre-cuts in a machine according to claim 1, characterized in that:
the diameter of the tire (6) is determined,
the total width of the tire (6) is determined,
a pitch or width of the band to be removed is established,
the number of turns giving rise to the pitch or width of the band to be removed is calculated with the determined diameter of the tire (6),
the blade (3.2) of the first cutting means (3) is positioned on one side of the tread (6.1) and the tire (6) is rotated to make a first perimetral cut,
once the perimetral cut is obtained, the blade (3.2) of the first cutting means (3) is moved laterally in synch with the rotation of the tire (6) giving rise to a helical cut with the previously determined pitch or width of the band to be removed,
a perimetral cut is made at the end of the helical cut.

16. The method according to claim 15, characterized in that once the opposite side of the band is reached, the second perimetral cut at the end of the helical cut is made as a continuation of the helical cut, where a complete groove is made without side movement giving rise to the perimetral cut.

17. The method according to claim 15, characterized in that the second perimetral cut at the end of the helical cut is made at the same time the first perimetral cut is made by means of a second blade (3.2).

18. The method according to claim 15, characterized in that the diameter of the tire (6), the width of the tire (6) or both are determined by means of proximity sensors providing a signal to processing means which determine said dimensions depending on the proximity to the sensor.

13. The method according to claim 15, characterized in that the diameter of the tire (6), the width of the tire (6) or both are determined by means of approaching rollers contacting the tire which provide a signal to processing means which determine said dimensions depending on the proximity to the sensor.
